(19) United States
(12) Patent Application Publication
(10) Pub. No.: US 2006/0095838 A1
(43) Pub. Date: May 4, 2006

(54) Object-oriented processing of tab text

(76) Inventors: Truc Nguyen, San Diego, CA (US); Katie Kuwata, Oceanside, CA (US); William Su, Riverside, CA (US)

Correspondence Address: TUCKER, ELLIS & WEST LLP, 1150 HUNTINGTON BUILDING, 925 EUCLID AVENUE, CLEVELAND, OH, 44115-1475, US

(21) Appl. No.: 11/252,485

(22) Filed: Oct. 18, 2005

Related U.S. Application Data
(63) Continuation-in-part of application No. 10/205,307, filed on Jul. 24, 2002.
(63) Continuation-in-part of application No. 10/201,886, filed on Jul. 24, 2002.
(63) Continuation-in-part of application No. 10/157,525, filed on May 28, 2002.

(51) Int. Cl. G06F 17/24; G06F 17/21

(52) U.S. Cl. 715/522; 715/513; 715/530

(57) ABSTRACT

An object-oriented processor for managing tab text information. The processor includes a data object and a view object. The data object is for storing data representative of the tab text, related attributes, and properties of the media on which the tab text is printed. The view object stores data representative of form and display control information for displaying the tab information in one of a single-line editable text format, a tab sheet thumbnail format or a readable text format.

This application is a Continuation-In-Part of U.S. application Ser. No. 10/205,307, filed on Jul. 24, 2002, U.S. application Ser. No. 10/201,886, filed on Jul. 24, 2002, and U.S. application Ser. No. 10/157,525, filed on May 28, 2002, the contents of all which are incorporated herein by reference.

### BACKGROUND OF THE INVENTION

This invention is related to an object-oriented approach of processing and editing tab text.

A tab, as is commonly known, is the protruding portion of, for example, a sheet of paper that typically extends beyond the general outline of the paper medium to facilitate an indexing function. A tab sheet manufactured to include the tab is used as a document separator in a document compilation to mark the beginning of a section or chapter that comprises the compilation of multiple pages of similar print medium. The tab is usually printed with an alphanumeric text caption to facilitate searching by a user for the section of interest in the compilation.

One conventional method for generating tab information requires the user to utilize an advanced word processing program to create a text box, and to position the text box where the user wants the tab text to appear on the tab document to be printed. Thus the user first needs to estimate the position of the tab index on the page, position the text box, select the font and size, modify the orientation for the text, enter the text, and finally, adjust the position of the text. Consequently, such a conventional tab management architecture involves many steps that are time-consuming, and furthermore, the tab information cannot be modified or re-positioned easily, if desired, at a later time.

What is needed is a more efficient and user-friendly method for managing tab generation and editing.

### SUMMARY OF THE INVENTION

The present invention disclosed and claimed herein, in one aspect thereof, comprises an object-oriented processor for managing tab text information. The processor includes a data object and a view object. The data object is for storing data representative of the tab text, related attributes, and properties of the media on which the tab text is printed. The view object stores data representative of form and display control information for displaying the tab information in one of a single-line editable text format, a tab sheet thumbnail format or a readable text format.

Still other objects and aspects of the present invention will become readily apparent to those skilled in this art from the following description wherein there is shown and described a preferred embodiment of this invention, simply by way of illustration of one of the best modes suited for to carry out the invention. As it will be realized, the invention is capable of other different embodiments and its several details are capable of modifications in various obvious aspects all without from the invention. Accordingly, the drawing and descriptions will be regarded as illustrative in nature and not as restrictive.

### BRIEF DESCRIPTION OF THE DRAWINGS

For a more complete understanding of the present invention and the advantages thereof, reference is now made to the following description taken in conjunction with the accompanying drawing, in which:

FIG. 1 illustrates a block diagram of the software object relationship in an operating system context, according to a disclosed embodiment;

FIG. 2 illustrates a user interface screenshot of the line view provided by the view object, according to a disclosed embodiment;

FIG. 3 illustrates a screenshot of a thumbnail view of multiple pages, according to a disclosed embodiment;

FIG. 4 illustrates a portion of a full page view; and

FIG. 5 is a block diagram illustrating the method of the present invention.

### DETAILED DESCRIPTION OF THE INVENTION

The disclosed architecture solves this problem by providing an object-oriented architecture for tab management by creating an algorithm that processes tab information that is structured as one or more self-organized objects. The algorithm also provides a user interface that allows a user to generate tab information that can easily be managed through a number of processes, including editing, inserting, deleting, copying, etc., all processes that are similar to the way in which text is handled in a standard word processor application.

The object-oriented nature of the disclosed architecture provides independent program modules written in an XML (extensible Markup Language) format that work together as a group at runtime without any prior linking or precompilation. Thus the objects interoperate strictly through messages passed between them.

A further aspect of the architecture is that a grouping of already-defined tab captions can be cut, copied, or pasted to another group of tab captions.

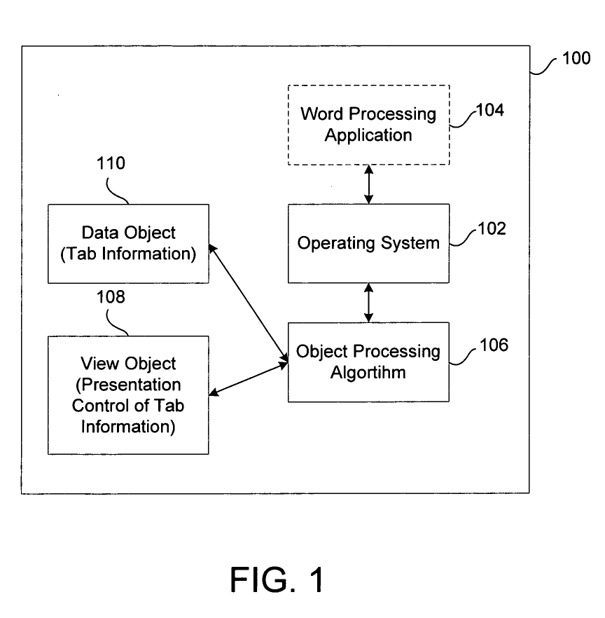

Referring now to FIG. 1, there is illustrated a block diagram of the software object relationship in an operating system context, according to a disclosed embodiment. In this particular embodiment, a printer controller system 100 includes an operating system 102 for operation of the system 100 across a network, or local to a user client. Where the object-based architecture is resident in a client computer (thick or thin) as an embodiment of system 100, the system 100 can include one or more applications, e.g., a word processing application 104 with which to utilize the features of the disclosed architecture. In either case, the user invokes the tab text printing features, e.g., within a browser, whether operating from the client system or the printer controller system 100. The system 100 also includes a software algorithm 106 that defines the behavior of the tab processing within the system 100 by performing object processing with a view model (or object) 108 and a data model (or object) 110. The code of the software algorithm 106 defines the system behavior during processing and editing of the tab objects.

The view model 108 incorporates various forms and display controls for displaying the tab information in a single-line editable-text format, or tab sheet thumbnail format, or readable-text format, all of which are illustrated hereinbelow.

The data object 110 includes the tab text, related tab attributes, and properties of the tab paper (used in, for example, a printer controller from which the tab sheet will be printed), all of which are encoded in an XML language format. The tab attributes include the text font name and size, the orientation and layout of the text in the tab area, the tab position on the tab sheet, and the position of the tab sheet in the overall document compilation.

The disclosed object architecture is implemented as a set of XML files that identify both the structure and the order of the tab text, as well as the properties of the tab paper on which the tab text is printed.

The user invokes the tab features to enter or review tab text. When the features are invoked, the user is presented with a dialog that prompts the user for options. When the document is to be printed, the user need only ensure that tab paper is in the peripheral output device (i.e., the printer controller).

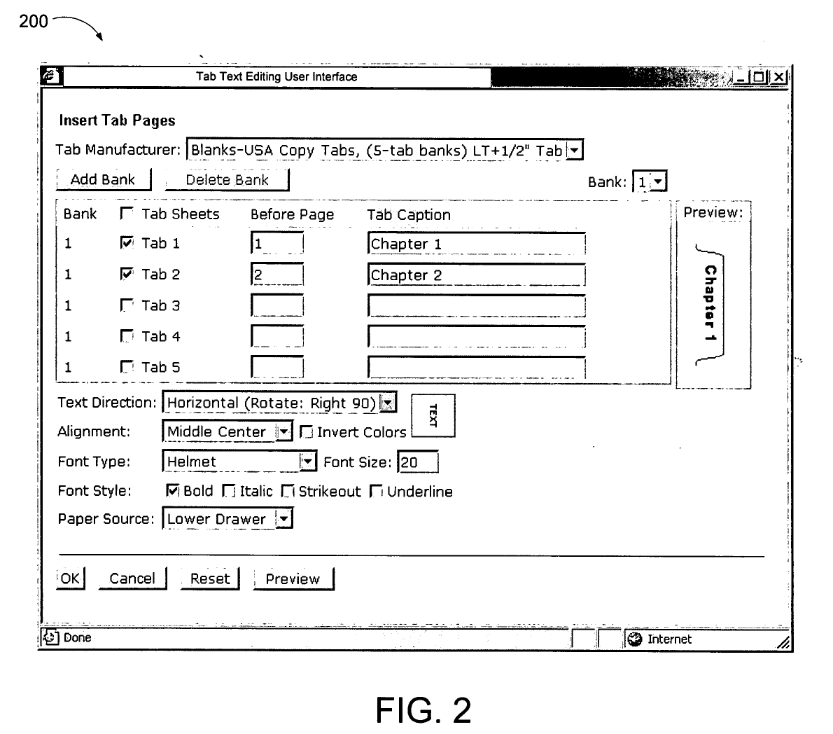

Referring now to FIG. 2, there is illustrated a user interface screenshot 200 of the line view provided by the view object, according to a disclosed embodiment. To create a tab, the user selects a menu option denoted Tab Set/New to define a collection of tab sheets as a tab object. The properties of each tab sheet of the collection can be changed by invoking a Tab Paper Properties selection. The Tab Paper Properties menu selection allows the user to modify the number of tabs per sheet, the tab dimensions, and the print properties of the tab text, i.e., font name, font size, and text orientation.

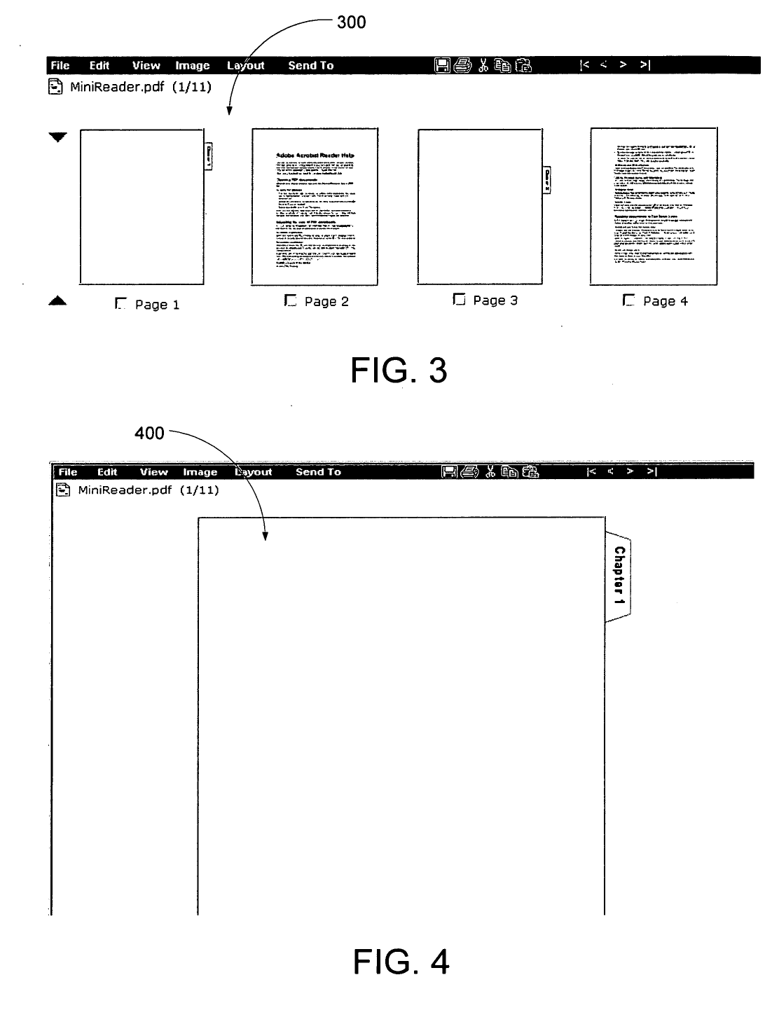

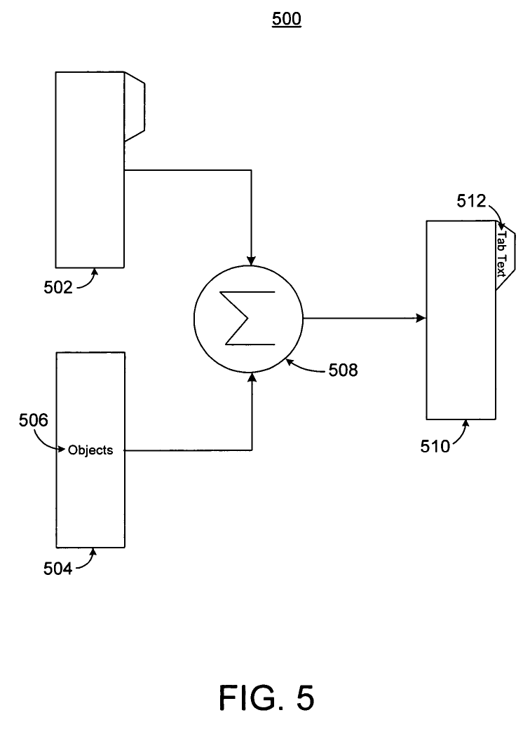

If the user selects a List View option, the text of all the corresponding tabs is displayed in a editable line-by-line list. If the user chooses a Thumbnail View selection, the tab text is displayed as small text in a protruding portion of the tab sheet thumbnail form. FIG. 3 illustrates a screenshot 300 of a thumbnail view of multiple pages, according to a disclosed embodiment. If the user chooses a Readable View selection, the tab text is displayed in a large tab sheet form. FIG. 4 illustrates a portion 400 of a full page view when the Readable View selection is made.

Continuing with the description of FIG. 2, the user then enters the tab caption in the order of the tab position. A blank entry indicates that no tab text is defined for that particular tab position. The tab positions are associated with the number of tabs per tab sheet, and then automatically wrap around to the first position of the next tab set. For example, if the paper is a first set of 5-tab paper, text captions 1-5 are positioned for the five tabs in the first set, and text caption 6 is positioned for the first tab in the next (or second) set of tab paper.

To save the tab information and layout, the user chooses a Tab Set/Save or File/Save selection. The tabs data and associated tab properties are then saved to a data file in the XML format. To copy a tab caption, the user selects the one or more tabs to be copied by placing a check mark in a location associated with the tab. The user then chooses an Edit/Copy selection to copy the tabs. The data of the check-marked tabs and associated properties are saved to a temporary clipboard file in the XML format.

To insert a new tab, the user positions the cursor at the place where the new tab is to be inserted, and chooses an Insert New Tab selection to insert a blank new tab. A blank tab is then inserted, and the view is updated. The user then enters caption text for the new tab.

To delete a tab caption, the user selects one or more tabs to be deleted (or cut) by placing a check mark in a field associated with each tab. The user then chooses an Edit/Delete selection to delete the tabs. The tab data and associated properties information are then deleted from the data object 110 and the view object 108 is updated accordingly.

To move a tab caption, the user selects the one or more tabs to be moved by placing a check mark in a field associated with each tab, and chooses an Edit/Cut selection to remove the tabs. The data and associated properties information of the cut tabs are then saved to a temporary clipboard file in an XML format. The user then positions the cursor at the destination where the information is to be moved, and chooses an Edit/Paste selection to copy the tab information from the clipboard to the destination.

The following example XML code specifies a tab information source file, the source file location, tab text properties, and tab text orientation for placement on the tab paper.

<tabfile>/pbtemp/tab/tab1.png</tabfile>
<tabsource>LC</tabsource>
<tableft>4992</tableft>
<tabtop>100</tabtop>
<tabheight>100</tabheight>
<tabwidth>20</tabwidth>
<tabfontname>Arial</tabfontname>
<tabfontsize>12</tabfontsize>
<taborientation>horizontal</ taborientation >

The following sample XML code specifies the tab orientation and text for various chapter tab sheets in a compilation.

<tabinfo>

<orientation>PORTRAIT</orientation>
<tabtext>Introduction</tabtext>
<tabtext>Chapter 1</tabtext>
<tabtext>Chapter 2</tabtext>

.
.

<tabtext>Chapter 10</tabtext>

</tab>

</tabinfo>

Referring now to FIG. 5 there is shown a block diagram 500 describing the interaction the various features of the present invention. A processor 508 acts as a summer to merge the document 502 with objects 506 stored in an object file 504. Typically, the object file 504 is an XML file and the objects 506 stored in the object file 504 are XML objects. After processing the document 502 and the object file 504, the processor 508 produces an output 510. The output comprising the document 502 and a tab text data 512 which is generated by processing the objects 506 stored in the object file 504.

The invention extends to computer programs in the form of source code, object code, code intermediate sources and object code (such as in a partially compiled form), or in any other form suitable for use in the implementation of the invention. Computer programs are suitably standalone applications, software components, scripts or plug-ins to other applications. Computer programs embedding the invention are advantageously embodied on a carrier, being any entity or device capable of carrying the computer program: for example, a storage medium such as ROM or RAM, optical recording media such as CD-ROM or magnetic recording media such as floppy discs. The carrier is any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the invention principles as described, will fall within the scope of the invention.

While in the preferred embodiment the present invention is implemented in software, as those skilled in the art can readily appreciate it may also be implemented in hardware or a combination of software and hardware. Although the preferred embodiment has been described in detail, it should be understood that various changes, substitutions, and alterations can be made therein without departing from the spirit and scope of the invention as defined by the appended claims. It will be appreciated that various changes in the details, materials and arrangements of parts, which have been herein described and illustrated in order to explain the nature of the invention, may be made by those skilled in the area within the principle and scope of the invention as will be expressed in the appended claims.

What is claimed:

1. A tab text management system comprising:
means adapted for prompting an associated user, via a thin client interface, for tab formatting data corresponding to an associated electronic document, which tab formatting data includes at least one data item from a set comprising tab text content, font name, font size, font orientation, font layout, tab text position, tab location and tab orientation;
means adapted for receiving, from the associated user via the thin client interface, the tab formatting data;
means adapted for storing the received tab formatting data into an associated object file;
means adapted for receiving a document data file representative of an electronic document associated with the tab formatting data;
means adapted for communicating the object file and the document data file via a network interface to an associated document rendering device;
means adapted for merging the document data file with the object file via the associated document rendering device;
means adapted for generating a document output from the merged document data file and object file; and
means adapted for communicating the generated document to an associated document processing device for rendering therefrom.

2. The tab text management system of claim 1 wherein the object file is comprised of an XML file.

3. The tab text management system of claim 2 wherein the object file includes a view object portion and a data object portion, and wherein the system further comprises processor means for generating the document inclusive of tabs in accordance with the object file.

4. The tab text management system of claim 3 further comprising:
means adapted for communicating the object file to an associated user so as to generate a visual representation thereof;
means adapted for receiving, from the associated user, modified tab formatting data;
means adapted for incorporating modified tab formatting data into the object file.

5. A method for tab text management comprising the steps of:
prompting an associated user, via a thin client interface, for tab formatting data corresponding to an associated electronic document, which tab formatting data includes at least one data item from a set comprising tab text content, font name, font size, font orientation, font layout, tab text position, tab location and tab orientation;
receiving, from the associated user via the thin client interface, the tab formatting data;
storing the received tab formatting data into an associated object file;
receiving a document data file representative of an electronic document associated with the tab formatting data;
communicating the object file and the document data file via a network interface to an associated document rendering device;
merging the document data file with the object file via the associated document rendering device;
generating a document output from the merged document data file and object file; and
communicating the generated document to an associated document processing device for rendering therefrom.

6. The method for tab text management of claim 5 wherein the object file is comprised of an XML file.

7. The method for tab text management of claim 6 wherein the object file includes a view object portion and a data object portion, and further comprising the step of generating the document inclusive of tabs in accordance with the object file.

8. The method for tab text management system of claim 7 further comprising the steps of:
communicating the object file to an associated user so as to generate a visual representation thereof;
receiving, from the associated user, modified tab formatting data;
incorporating modified tab formatting data into the object file.

9. A computer-readable medium of instructions with computer-readable instructions stored thereon for tab text management comprising:
instructions for prompting an associated user, via a thin client interface, for tab formatting data corresponding to an associated electronic document, which tab formatting data includes at least one data item from a set comprising tab text content, font name, font size, font orientation, font layout, tab text position, tab location and tab orientation;
instructions for receiving, from the associated user via the thin client interface, the tab formatting data;
instructions for storing the received tab formatting data into an associated object file;
instructions for receiving a document data file representative of an electronic document associated with the tab formatting data;
instructions for communicating the object file and the document data file via a network interface to an associated document rendering device;
instructions for merging the document data file with the object file via the associated document rendering device;
instructions for generating a document output from the merged document data file and object file; and
instructions for communicating the generated document to an associated document processing device for rendering therefrom.

10. The computer-readable medium of instructions with computer-readable instructions stored thereon for tab text management of claim 9 wherein the object file is comprised of an XML file.

11. The computer-readable medium of instructions with computer-readable instructions stored thereon for tab text management of claim 10 wherein the object file includes a view object portion and a data object portion, and further comprising instructions for generating the document inclusive of tabs in accordance with the object file.

12. The computer-readable medium of instructions with computer-readable instructions stored thereon for tab text management system of claim 11 further comprising:
instructions for communicating the object file to an associated user so as to generate a visual representation thereof;
instructions for receiving, from the associated user, modified tab formatting data;
instructions for incorporating modified tab formatting data into the object file.

13. A computer-implemented method for tab text management comprising the steps of:
prompting an associated user, via a thin client interface, for tab formatting data corresponding to an associated electronic document, which tab formatting data includes at least one data item from a set comprising tab text content, font name, font size, font orientation, font layout, tab text position, tab location and tab orientation;
receiving, from the associated user via the thin client interface, the tab formatting data;
storing the received tab formatting data into an associated object file;
receiving a document data file representative of an electronic document associated with the tab formatting data;
communicating the object file and the document data file via a network interface to an associated document rendering device;
merging the document data file with the object file via the associated document rendering device;
generating a document output from the merged document data file and object file; and
communicating the generated document to an associated document processing device for rendering therefrom.

14. The computer-implemented method for tab text management of claim 13 wherein the object file is comprised of an XML file.

15. The computer-implemented method for tab text management of claim 14 wherein the object file includes a view object portion and a data object portion, and further comprising the step of generating the document inclusive of tabs in accordance with the object file.

16. The computer-implemented method for tab text management system of claim 15 further comprising the steps of:
communicating the object file to an associated user so as to generate a visual representation thereof;
receiving, from the associated user, modified tab formatting data;
incorporating modified tab formatting data into the object file.
